(19) United States
(12) Patent Application Publication
(10) Pub. No.: US 2011/0214982 A1
(43) Pub. Date: Sep. 8, 2011

(54) LEVITATION MICROREACTOR

(76) Inventor: Jeffrey John Hagen, Plymouth, MN (US)

(21) Appl. No.: 12/719,199

(22) Filed: Mar. 8, 2010

(51) Int. Cl. B01J 19/08; B05B 5/025; G01S 11/14; B01J 19/00; C25B 1/00; F17D 1/08

(52) U.S. Cl. 204/157.15; 361/226; 73/570.5; 422/236; 422/119; 422/108; 422/128; 422/186.01; 422/186.04; 137/13

(57) ABSTRACT

Technologies are generally described for a levitation microreactor adapted to facilitate a chemical reaction. The levitation microreactor may comprise one or more levitation zones arranged in spatial communication with one another, each levitation zone including a levitator that is effective to levitate a reactant droplet. In some examples, a first levitation zone may include a first levitator effective to levitate a first reactant droplet, while a second levitation zone may include a second levitator effective to levitate a second reactant droplet. The second reactant droplet may be distinct from the first reactant droplet. Some example microreactors may further include a third levitation zone that is arranged in spatial communication with the first and second levitation zones. The third levitation zone may be effective to facilitate a chemical reaction on the first and second reactant droplets while the first and second reactant droplets are levitated to produce a product.

### BACKGROUND

Unless otherwise indicated herein, the materials described in this section are not prior art to the claims in this application and are not admitted to be prior art by inclusion in this section.

Levitated microparticles and/or microdroplets may be used in a reaction zone investigating chemical reactions on small scales. In these analyses, levitating the microparticle or microdroplet provides a reaction environment with reduced surface contamination and a reduced level of analysis interference from a containing vessel. The reaction zone with levitated microparticles and/or microdroplets can be analyzed with optical detection methods such as Raman and fluorescence spectroscopes.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example levitation microreactor arranged in accordance with at least some embodiments herein;

FIG. 2 illustrates an example levitation microreactor arranged in accordance with at least some embodiments herein;

FIG. 3 illustrates an example levitator and droplet injector in accordance with at least some embodiments described herein;

FIG. 4 illustrates an example levitation microreactor in accordance with at least some embodiments herein;

FIG. 5 depicts a flow diagram for an example process for a levitation microreactor;

FIG. 6 illustrates a computer program product for use in a levitation microreactor that is adapted in accordance with at least some embodiments described herein; and

FIG. 7 is a block diagram illustrating an example computing device that is arranged to control a levitation microreactor that is adapted in accordance with at least some embodiments of the present disclosure;

all arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

This disclosure is generally drawn, inter alia, to methods, apparatus, systems, devices, and computer program products related to a levitation microreactor.

Briefly stated, technologies are generally described for a levitation microreactor adapted to facilitate a chemical reaction. The levitation microreactor may comprise one or more levitation zones arranged in spatial communication with one another, each levitation zone including a levitator that is effective to levitate a reactant droplet. In some examples, a first levitation zone may include a first levitator that is effective to levitate a first reactant droplet, while a second levitation zone may include a second levitator effective to levitate a second reactant droplet. The second reactant droplet may be distinct from the first reactant droplet. Some example microreactors may further include a third levitation zone that is arranged in spatial communication with the first and second levitation zones. The third levitation zone may be effective to facilitate a chemical reaction on the first and second reactant droplets while the first and second reactant droplets are levitated to produce a product.

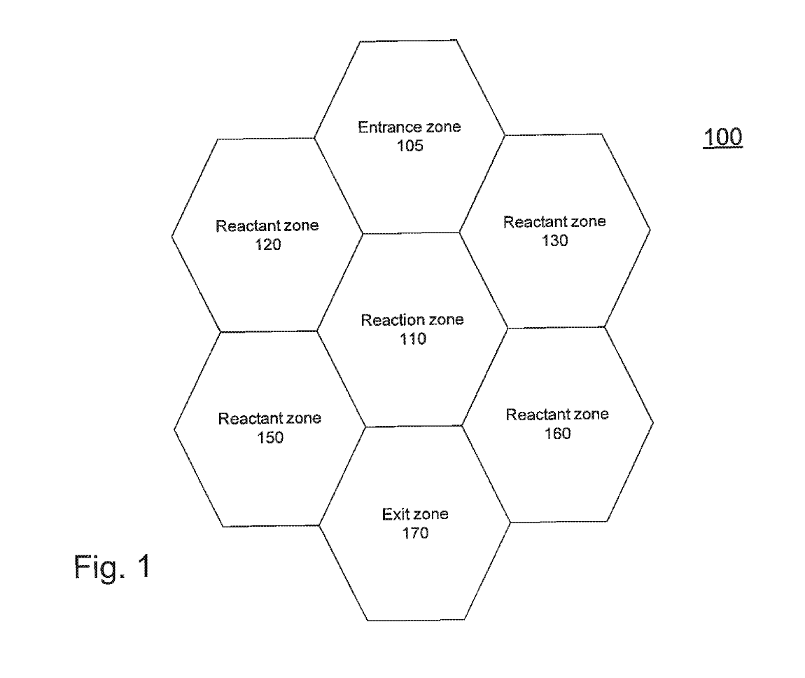

FIG. 1 illustrates an example levitation microreactor arranged in accordance with at least some embodiments herein. A levitation microreactor 100 may include, an entrance levitation zone 105, a reaction levitation zone 110, one or more reactant levitation zones 120, 130, 150, 160 and an exit zone 170, all adapted in spatial communication. In some examples, zones 105, 110, 120, 130, 150, 160, 170 may be walled chambers and/or defined volumes or areas. As discussed in more detail below, either entrance levitation zone 105 or reactant levitation zones 120, 130, 150 and 160 may be arranged to inject and levitate and/or move one or more reactant droplets into microreactor 100. Once injected, the reaction droplets may be moved to reaction levitation zone 110. Reaction levitation zone 110 may be adapted to facilitate a desired chemical reaction on the levitated reactants to produce a product. Depending upon the need of the chemical reaction, reactant levitation zones 120, 130, 150, 160, 170 may be used to store additional reactants. Exit zone 170 may be adapted to process and collect the reaction product.

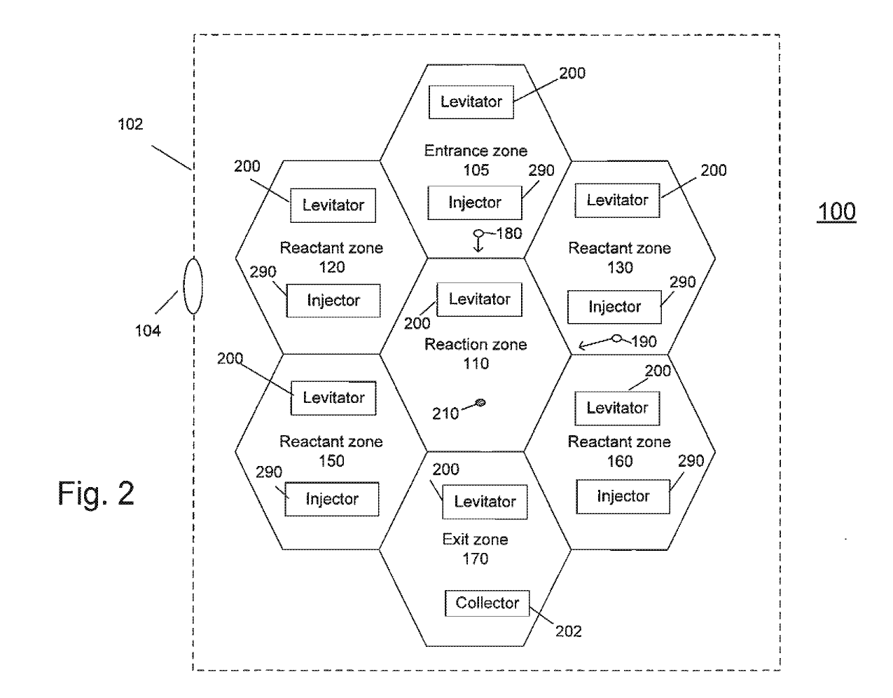

FIG. 2 illustrates an example levitation microreactor arranged in accordance with at least some embodiments described herein. The microreactor of FIG. 2 is substantially similar to microreactor 100 of FIG. 1, with additional details. Those components in FIG. 2 that are labeled identically to components of FIG. 1 will not be described again for the purposes of clarity.

As shown in FIG. 2, microreactor 100 may be sealed in a housing 102 including at least one port 104. Entrance levitation zone 105, reactant levitation zones 120, 130, 150, 160, reaction levitation zone 110 and exit levitation zone 170 may each include a levitator 200. Entrance zone 105 and reactant zones 120, 130, 150 and 160 may also include a droplet injector 290. Droplet injector 290 may be configured to inject first and second reactant droplets 180, 190 into a respective zone. Levitator 200 can be configured to generate a levitation field to levitate droplets 180, 190 as is discussed below. Each zone may be configured to include a respective levitator 200 and/or injector 290 or multiple zones may share single or multiple levitators 200 and/or injectors 290. Reaction zone 110 may be configured to facilitate a reaction on reactant droplets 180, 190 to produce a product droplet 210.

Exit zone 170 may include a product collector 202 effective to collect product droplets 210 produced when a reaction is carried out on reactant droplets 180, 190. In examples where exit zone 170 includes walls, product collector 202 may include an outlet configured to be in fluid communication with the walls of exit zone 170. Exit zone 170 may also include a levitator 200. Levitator 200 in exit zone 170 may be configured to levitate and/or move product droplet 210 to a desirable location for analysis or for further processing.

A droplet can include, for example, a liquid droplet or a solid particle. In some examples, levitation microreactor 100 may be used for single phase reactions, such as solid phase reactions and liquid phase reactions. In some examples, levitation microreactor 100 may be used with mixed phase reactions, including, without limitation, mixed solid/liquid phase reactions, mixed solid/gaseous phase reactions, and/or mixed liquid/gaseous phase reactions. Microreactor 100 may be used for multiple step synthesis as is explained throughout.

In some examples, levitator 200 could be one or more or a combination of an aerodynamic levitator, an acoustic levitator, an electrostatic levitator, an electromagnetic levitator, an optical levitator, a magnetic levitator, an ultrasonic levitator, and/or a hybrid levitator. Any levitator that is capable of levitating a droplet may be used.

In some examples, levitator 200 may be configured to levitate and/or move a reactant droplet 180, 190 or product 210 electrostatically and acoustically and, therefore, may be capable of levitating both a charged or non-charged (neutral) droplet. In some examples, a hybrid levitator may incorporate components for various levitating mechanisms in one construction. Structures in these examples may allow the levitator to levitate reactant droplets 180, 190 and/or product droplet 210 using two or more levitating mechanisms. Alternatively, the hybrid levitator may be a combination of two or more sub-levitators both being of the same or of different constructions. A desired levitator may be activated by activating a desired sub-levitator.

Levitators 200 in different zones may employ different levitation mechanisms. The geometry of microreactor 100 can be adjusted to allow for additional adjacent levitation zones or a reduced number of adjacent levitation zones as the desired reaction requires.

Gaseous reactants may be used in levitation microreactor 100 by sealing microreactor 100 in sealed shell housing 102 with one or more ports 104. Ports 104 allow for the transfer of droplets into and out of housing 102. The gas could be continuously contained within microreactor 100 or introduced and flushed out via ports 104 as part of a reaction. Gas pulled out of the microreactor 100 can be collected and recycled back into microreactor 100 either by directly pumping the gas back in or collecting the gas in cold traps or other collection mechanisms.

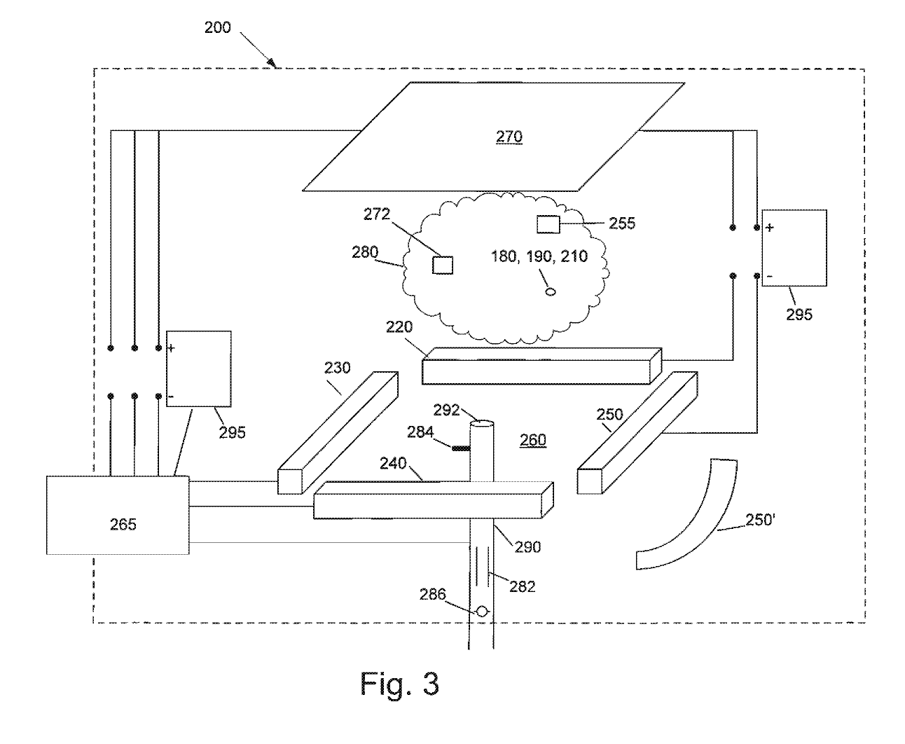

FIG. 3 illustrates an example levitator and droplet injector in accordance with at least some embodiments described herein. Those components in FIG. 3 that are labeled identically to components of FIGS. 1 and 2 will also not be described again for the purposes of clarity.

In some examples, levitator 200 may be an electrostatic levitator. In one embodiment, the electrostatic levitator comprises a plurality of levitation electrode bars and a top plate, wherein the levitation electrode bars are disposed opposite to each other in pair and thereby define a bottom plane. FIG. 3 schematically illustrates an electrostatic levitator 200 effective to levitate and/or move reactant droplet 180, 190 and/or product droplet 210. Electrostatic levitator 200 may include a plurality of levitation electrode bars, 220, 230, 240 and/or 250, 250′, a top plate 270, a position detector 255, a reaction detector 272, and/or a power source 295 all in communication with a processor 265. A droplet injector 290 may be configured to inject droplets 180, 190 into levitator 200 as is explained in more detail below. Droplet injector 290 may also be arranged in communication with processor 265. Electrode bars 220, 230, 240 and 250 may be disposed opposite to each other in pairs. Electrode bars 220, 230, 240 and 250 define a bottom plane 260 of a levitation area 280. Levitator 200 may include four, six, or any other number of levitation electrode bars. The levitation electrode bars may be mounted on nonconductors. In some examples, a top cross-section of the levitation electrode bars may define a rectangle as shown at, for example, element 250. In other examples, a top cross-section of the levitation electrode bars may be arcuate as shown at, for example, element 250′. In examples where arcuate top cross-sections are used, bottom plane 260 may have a circular configuration. Other shapes may be used for the top cross-section of the electrode bars. Top plate 270 may be substantially parallel to the bottom plane 260 and may define a top plane of levitation zone 280. Levitation electrode bars 220, 230, 240 and 250 and top plate 270 can be configured to be in electric communication with power source 295. Power source 295 may be configured to generate a voltage potential between levitation electrode bars 220, 230, 240 and 250 and top plate 270. Levitator 200 may be used to move positively or negatively charged droplets.

A size of levitation zone 280 may be varied by altering a number factors including, for example, a size of levitation electrode bars 220, 230, 240, 250, a distance between top plate 270 and bottom plane 260, one or more voltages generated by power source 295, a size and amount of electric charges on reactant droplets 180, 190, 210 and/or the type of the reactants in droplets 180, 190.

In some examples, voltages produced by power source 295 may be in a range from about 100V to about 1 kV, from about 100V to about 33 kV, or from about 100V to about 60 kV. In some examples, a size of reactant droplets 180, 190 may be in a range from about 100 nL to about 30 μL. In other examples, a size of reactant droplets 180, 190 may be in a range from about 5 μl, to about 10 μL.

A size of levitation electrode bars 220, 230, 240, 250 may be varied based on a particular size and type of reactant droplets 180, 190. In some examples, a length of the levitation electrode bar may have a length in a range from about 0.1 cm to about 10 cm. Levitation electrode bars 220, 230, 240, 250 may define bottom plane 260 of the levitation zone 280 having a length in a range from about 1 cm to about 10 cm. In some examples, bottom plane 260 may have a length that is in a range from about 3 cm to about 5 cm. In some other examples, bottom plane 260 may have a length that is in a range from about 4 cm to about 5 cm.

Top plate 270 may be positioned with a distance of about 1 cm to about 10 cm from bottom plane 260. In some examples, top plate 270 may be from about 3 cm to about 5 cm from bottom plane 260.

Top plate 270 and levitation electrode bars 220, 230, 240, and 250 may be made of a conductive material. In some examples, top plate 270 and levitation electrode bars 220, 230, 240 and 250 may be made of metal. In other examples, levitation electrode bars 220, 230, 240 and 250 may include, without limitation, stainless steel, iron, zinc, aluminum, copper, silver, gold, platinum, chromium, and/or various alloys. In some examples, the top plate 270 and/or levitator electrode bars 220, 230, 240 and 250 may be coated with anticorrosive material or inert material, such as polytetrafluoroethylene (PTFE).

As discussed above, droplet injector 290 may be configured to inject droplets 180, 190 into levitator 200. In some examples, processor 265 may be configured to control droplet injector 290 to inject a droplet. Droplet injector 290 may include a capillary tube 282, a striker 284, a syringe pump 286 and/or an opening 292. Opening 292 may be placed proximate to bottom plane 260 and positioned to point into levitation field 280. Reactant droplets 180, 190 may be injected into levitation field 280 by droplet injector 290 via, for example, gaseous diffusion, direct injection, or with other levitated particles and/or droplets.

In some examples, droplet injector 290 may include capillary tube 282 or a bundle of capillary tubes. In some examples, capillary tube 282 may have a diameter that is in a range from about 100 μm to about 2 mm. In other examples, capillary tube 282 may have a diameter in a range from about 100 μm to about 800 μm.

In order to generate electrostatic levitation on reactant droplets 180, 190, reactant droplets 180, 190 could be electrically charged with either a positive charge or a negative charge. Electric charges on reactant droplets 180, 190 may be provided by a charged or piezoelectric droplet injector 290. Reactant droplets 180, 190 may include a solution having an electrolyte and a solvent. The electrolyte in the solution may aid in holding an electric charge on the surface of the reactant droplet. The electrolyte may be a salt, a base, or an acid. By way of example, the electrolyte may be a halide, nitrate, sulfate, hydroxide or phosphate of an alkali metal, alkaline earth metal or hydrogen. Other electrolytes include, for example, NaCl, KCl, NaBr, KBr, NaI, KI, NaNO₃, KNO₃, CaCl₂, Ca₂SO₄, Ca(NO₃)₂, NaOH, KOH, Ca(OH)₂, HCl, HBr, HI, H₂SO₄, HNO₃, H₃PO₄, or mixtures thereof. The solvent of droplets 180, 190 may be polar or non-polar, and/or protic or aprotic. In some examples, the solvent may be water, and/or an alcohol, ketone, hydrocarbon, halogenated hydrocarbon, ester, ether, amide, amine, or sulfoxide. Representative solvents may include without limitation H₂O, alcohols such as methanol, ethanol, n-propanol, 2-propanol, 1-butanol, 2-butanol, t-butanol, t-butyl-2-ol, ketones such as acetone or methylethyl ketone (MEK), hydrocarbons such as pentane, hexane, benzene, or toluene, halogenated hydrocarbons such as dimethylene chloride or chloroform, dimethylsulfoxide (DMSO), dimethylformamide (DMF), dihydrofurane (DHF), or a combination thereof.

Droplet injector 290 may further include a striker 284 that can be adapted to aid in the release of the reactant droplet into the levitation field 280 by tapping injector 290. In some examples, droplet injector 290 may include a syringe pump 286 to facilitate injection of reactant droplets 180, 190.

Levitation field 280 can be generated by creating a voltage potential difference between one or more of levitation electrode bars 220, 230, 240, 250 and top plate 270. Adjustment of voltage potential differences between levitation electrode bars 220, 230, 240, 250 and top plate 270 can create a field well where a droplet 180, 190, 210 may reside and become trapped by the levitation field 280. Changing voltage potential differences between levitation electrode bars 220, 230, 240, 250 and top plate 270 may cause perturbations in levitation field 280. The perturbations can be used to move reactant droplets 180, 190 or reaction product 210 into a collector vessel 202 (FIG. 2) or into an adjacent levitation zone (FIG. 2). Droplets 180, 190, 210 may also be moved from one levitation zone to another by the means of air pressure, ultrasound blast, or by light tweezers.

Still referring to FIG. 3, in some examples, levitator 200 may further include a position detector 255. Position detector 255 may be adapted to detect a position of droplet 180, 190, 210 in levitation area 280 and responsively generate a position signal based on a detected position. Processor 265 may be adapted to receive the position signal and responsively generate a control signal to control an output voltage of power supply 295. The control signal may thus change electrical potentials (voltages) between levitation electrode bars 220, 230, 240, 250 and top plate 270 and thereby move droplets 180, 190, 210.

Levitator 200 may include a reaction detector 272. Reaction detector 272 may be configured to monitor a progress of a chemical reaction in levitation zone 280 (FIG. 2), and generate a reaction signal with information regarding the progress of the chemical reaction. For example, the reaction signal may include information relating to the types and amounts of molecules in a reaction product. In some examples, reaction detector 272 may include a laser detector, a light absorbance spectroscopy detector, a Raman spectroscopy detector, an IR spectroscopy detector, or a UV spectroscopy detector. Processor 265 may be adapted to receive the reaction signal and responsively generate a control signal to control an output voltage of power supply 295.

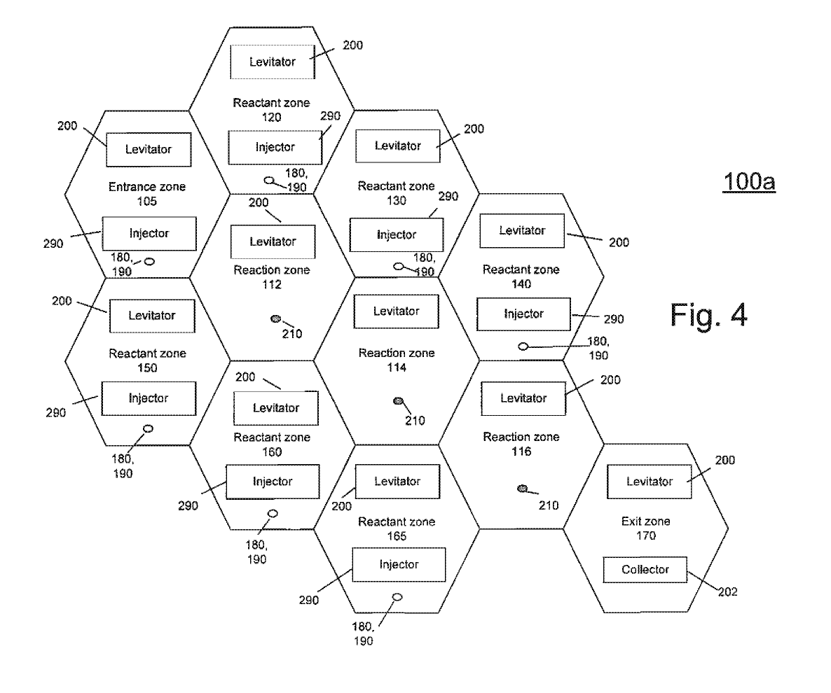

FIG. 4 illustrates an example levitation microreactor in accordance with at least some embodiments herein. Those components in FIG. 4 that are labeled identically to components of FIGS. 1, 2 and 3 will not be described again for the purposes of clarity.

As shown in FIG. 4, levitation microreactor 100a may include, in some examples, an entrance zone 105, six reactant levitation zones, 120, 130, 140, 150, 160 and/or 165 three reaction zones, 112, 114 and/or 116 and an exit zone 170. A multiple step synthesis may be carried out using levitation microreactor 100a, where each step of the reaction may be carried out its own reaction zone. By using three adjacent reaction levitation zones 112, 114, 116 microreactor 100a may implement a reaction stream system, in which a multiple-step reaction synthesis may be carried out where one or two reactants can be added in each step. The geometry of the zones can be altered to allow additional reactants at any or all of the steps.

In some examples, when operating microreactor 100a, a first reactant droplet 180, 190 may be injected into entrance levitation zone 105 and other reactant droplets 180, 190 can be injected into one or more of the reactant levitation zones 120, 130, 140, 150, 160 and/or 165. After at least the first reactant droplet 180, 190 is moved into reaction levitation zone 112, reactants in reactant zones 120, 130, 140, 150, 160 and/or 165 can be added. While a reaction is performed on the reactants, entrance levitation zone 105 and the reactant levitation zones 120, 130, 140, 150, 160 and/or 165 can be reloaded with additional reactants, respectively. When the reaction in the reaction levitation zone 112 is complete, any resultant product 210 can be moved into reaction levitation zone 114 and combined with reactants from reactant levitation zones 120, 130, 140, 150, 160 and/or 165. As this occurs, the first reactant in entrance zone 105 can be moved into the reaction levitation zone 112 and combined with one or more reactants from the reactant levitation zones 120, 130, 140, 150, 160 and/or 165. Microreactor 100a can once again be paused (or monitored) while both reactions in the reaction zones 112 and 114 are carried out. During this time, entrance levitation zone 105 can be loaded with the first reactant and one or more of the reactant levitation zones 120, 130, 140, 150, 160 and/or 165 can be reloaded with the corresponding reactants. As the process proceeds, each of the steps of the synthesis may take place at substantially the same time (or overlapping in time) in three reaction levitation zones 112, 114 and/or 116. Therefore, the described process can be implemented in a microreactor with greater reactant throughput (e.g., 2 times, 3 times, etc.) than that of a single reaction zone system. The microreactor can also be expanded for further reaction steps by adding additional reaction zones.

Among other benefits, microreactor 100, 100a may be implemented without a physical containment system and therefore interference and contaminations from vessels walls may be reduced. As multiple types of levitators may be used, microreactor 100, 100a may be used to introduce and remove particulate reactants and/or catalytic surfaces. Levitation systems may utilize solvent evaporation to increase component concentration during a reaction. In some examples, microreactor 100, 100a allows for the precise control of time and amount of component delivery in a reaction. There may be less diffusion processes leading to premature or excess delivery. Multiple step synthesis reactions may be performed. Further, reactions using multiple phases (e.g. liquid, gas, solid) may be carried out.

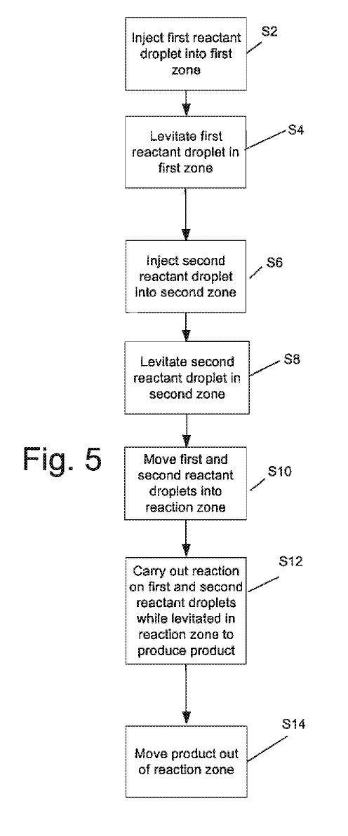

FIG. 5 depicts a flow diagram for an example process for a levitation microreactor in accordance with at least some embodiments of the present disclosure. The process in FIG. 5 could be implemented using, for example, microreactor 100, 100a discussed above. An example process may include one or more operations, actions, or functions as illustrated by one or more of blocks S2, S4, S6, S8, S10, S12 and/or S14. Although illustrated as discrete blocks, various blocks may be divided into additional blocks, combined into fewer blocks, or eliminated, depending on the desired implementation. Processing may begin at block S2.

At block S2, “inject first reactant droplet into first zone”, a first injector of a microreactor may be configured to inject a first reactant droplet into a first zone of the microreactor. The first injector could be, for example, disposed inside, or proximate to the first zone. The first zone of the microreactor could be, for example, an entrance zone or a reactant zone. Processing may continue from block S2 to block S4.

At block S4, “levitate first reactant droplet in first zone”, a first levitator in the first zone of the microreactor may be configured to levitate the first droplet in the first zone. Processing may continue from block S4 to block S6.

At block S6, “inject second reactant droplet into second zone” second injector of the microreactor may be configured to inject a second reactant droplet into a second zone of the microreactor. The second injector could be, for example, disposed inside, or proximate to the second zone. The second zone could be, for example, an entrance zone or a reactant zone. Processing may continue from block S6 to block S8.

At block S8, “levitate second reactant droplet in second zone”, a second levitator in the second zone of the microreactor may be configured to levitate the second droplet in the second zone. Processing may continue from block S8 to block S10.

At block S10, “move first and second reactant droplets into reaction zone”, the first droplet in the first zone and the second droplet in the second zone may be moved into a reaction zone. In some examples, the movement may be performed by the first and second levitators. Processing may continue from block S10 to block S12.

At block S12, “carry out reaction on first and second reactant droplets while levitated in reaction zone to produce product”, a reaction may be facilitated for the first and second reactant droplets while the droplets are levitated in the reaction zone to produce a product. In some examples, the first and second reactant droplets may be levitated by the first and second levitators. In other examples, the first and second reactant droplets may be levitated by a third levitator in the reaction zone. The reaction may be facilitated by bringing the first and second reactant droplets in proximity with one another. Processing may continue from block S12 to block S14.

At block S14, “move product out of reaction zone”, the product of the reaction may be moved out of the reaction zone. In some examples, the product may be moved by the first, second or third levitators. In other examples, the product may be moved by a fourth levitator in an exit zone.

Various analytic methods may be used to evaluate the completion of a reaction. For example, chronoamperometry, light (infra red, ultraviolet) absorbance spectroscopy, Raman spectroscopic analysis, fluorescence spectroscopy, chemiluminescence spectroscopy, Mass spectrum, and chromatographic analysis such as high performance liquid chromatography may be used.

Reaction time may be controlled by effective path length and/or an effective speed of movement for a droplet. Depending upon the type of levitator used in the microreactor, the effective path length and the effective speed for the droplet may be controlled by various mechanisms. For example, for the electrostatic levitator described above, the effective path length and the effective speed of the droplet may be controlled by the perturbation of the electric field. In addition, the effective path length may be affected by the size of the reaction zone. The effective speed of the droplet may be affected by the speed of a gaseous reactant flowing through the reaction zone.

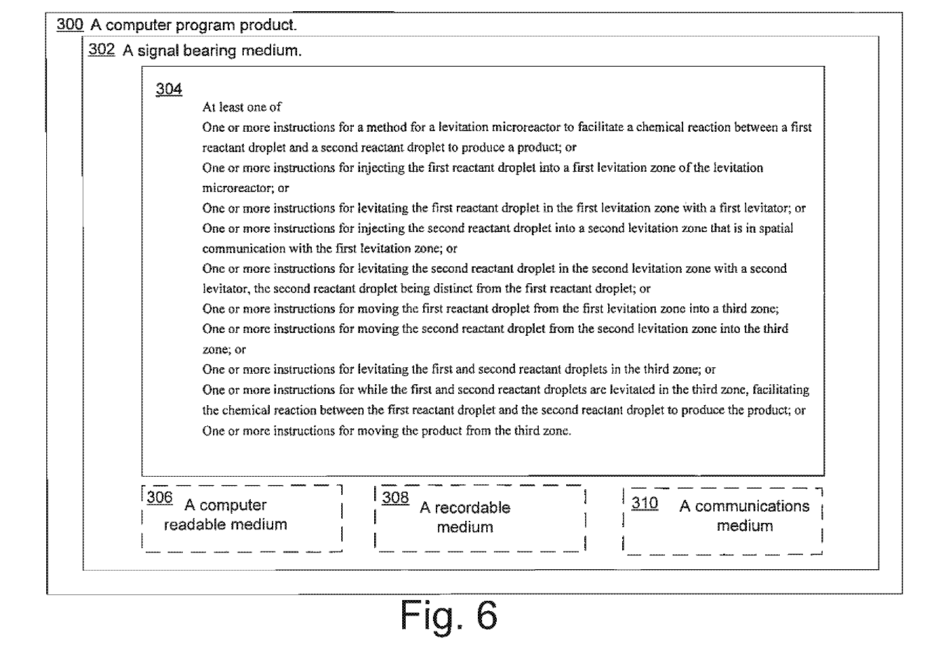

FIG. 6 illustrates a computer program product for use in a levitation microreactor that is adapted in accordance with at least some embodiments described herein. Program product 300 may include a signal bearing medium 302. Signal bearing medium 302 may include one or more instructions 304 that, when executed by, for example, a processor, may provide the functionality described above with respect to FIGS. 1-5. Thus, for example, referring to microreactor 100, 100a processor 265 may undertake one or more of the blocks shown in FIG. 6 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

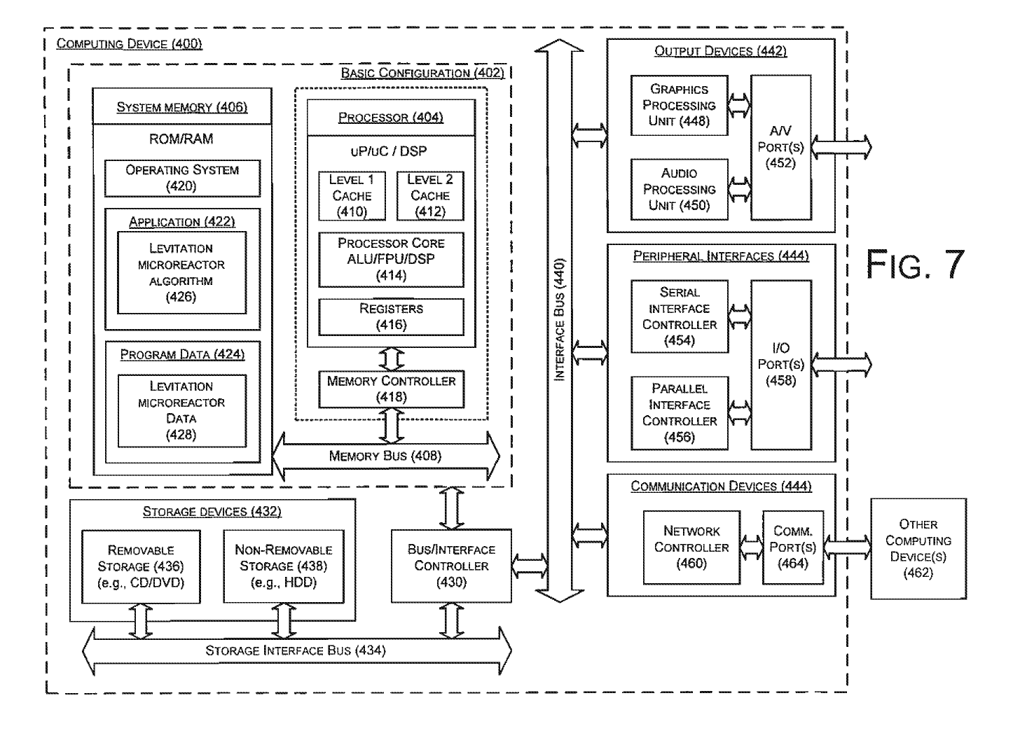

FIG. 7 is a block diagram illustrating an example computing device 400 that is arranged to control a levitation microreactor that is adapted in accordance with at least some embodiments of the present disclosure. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof, Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a levitation microreactor algorithm 426 that is arranged to perform the functions as described herein including those described with respect to FIGS. 1-6. Program data 424 may include levitation microreactor data 428 that may be useful for a levitation microreactor algorithm as is described herein. In some embodiments, application 422 may be arranged to operate with program data 424 on operating system 420 such that a levitation microreactor process may be effectuated. This described basic configuration 402 is illustrated in FIG. 7 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A levitation microreactor adapted to facilitate a chemical reaction between a first reactant droplet and a second reactant droplet to produce a product, the levitation microreactor comprising:
a first levitation zone wherein the first levitation zone includes a first levitator effective to levitate the first reactant droplet in the first levitation zone;
a second levitation zone distinct from, and arranged in spatial communication with the first levitation zone, the second levitation zone including a second levitator effective to levitate the second reactant droplet in the second levitation zone, the second reactant droplet being distinct from the first reactant droplet; and
a third levitation zone, wherein the third levitation zone is arranged in spatial communication with the first and second levitation zones, wherein the third levitation zone is effective to facilitate the chemical reaction on the first and second reactant droplets while the first and second droplets are levitated such that the product of the chemical reaction is produced in the third levitation zone.

2. The levitation microreactor as recited in claim 1, wherein the first and second levitators are distinct from one another.

3. The levitation microreactor as recited in claim 1, further comprising a droplet position detector in the first levitation zone, the droplet position detector effective to generate a first signal that identifies a position of the first droplet in the first levitation zone.

4. A levitation microreactor adapted to facilitate a chemical reaction between a first reactant droplet and a second reactant droplet to produce a product, the levitation microreactor comprising:
a first levitation zone wherein the first levitation zone includes a first levitator effective to levitate the first reactant droplet;
a second levitation zone arranged in spatial communication with the first levitation zone, the second levitation zone including a second levitator effective to levitate the second reactant droplet, the second reactant droplet being distinct from the first reactant droplet;
a third levitation zone, wherein the third levitation zone is arranged in spatial communication with the first and second levitation zones, wherein the third levitation zone is effective to facilitate the chemical reaction on the first and second reactant droplets while the first and second droplets are levitated such that the product of the chemical reaction is produced in the third levitation zone;
a droplet position detector in the first levitation zone, the droplet position detector effective to generate a first signal that identifies a position of the first droplet in the first levitation zone; and
a processor arranged in communication with the droplet position detector, the processor adapted to receive the first signal and to generate a second signal in response to the first signal, the second signal effective to control the first levitator to move the first droplet.

5. The levitation microreactor as recited in claim 1, wherein each of the first and second levitators comprises one of an acoustic levitator, an electrostatic levitator, an electromagnetic levitator, an optical levitator, a magnetic levitator, an ultrasonic levitator or a hybrid levitator.

6. The levitation microreactor as recited in claim 1, wherein the first and second levitators are hybrid acoustic/electrostatic levitators.

7. The levitation microreactor as recited in claim 1, wherein at least the first levitator is an electrostatic levitator and wherein the electrostatic levitator comprises:
at least one electrode bar; and
an electrode plate configured in spatial arrangement with the electrode bar;
wherein the electrode bar and the electrode plate are effective to generate a levitation field in a levitation area when a potential difference is applied between the electrode bar and the electrode plate.

8. A levitation microreactor adapted to facilitate a chemical reaction between a first reactant droplet and a second reactant droplet to produce a product, the levitation microreactor comprising:
a first levitation zone wherein the first levitation zone includes a first levitator effective to levitate the first reactant droplet;
a second levitation zone arranged in spatial communication with the first levitation zone, the second levitation zone including a second levitator effective to levitate the second reactant droplet, the second reactant droplet being distinct from the first reactant droplet;
a third levitation zone, wherein the third levitation zone is arranged in spatial communication with the first and second levitation zones, wherein the third levitation zone is effective to facilitate the chemical reaction on the first and second reactant droplets while the first and second droplets are levitated such that the product of the chemical reaction is produced in the third levitation zone;
wherein at least the first levitator is an electrostatic levitator and wherein the electrostatic levitator comprises:
at least one electrode bar; and
an electrode plate configured in spatial arrangement with the electrode bar;
wherein the electrode bar and the electrode plate are effective to generate a levitation field in a levitation area when a potential difference is applied between the electrode bar and the electrode plate;
a power supply arranged in communication with the electrode bar and the electrode plate, wherein the power supply is effective to generate the potential difference;
a droplet position detector in the first levitation area, the droplet position detector effective to generate a first signal that identifies a position of the first droplet in the first levitation area; and
a processor arranged in communication with the droplet position detector, the processor adapted to receive the first signal and to generate a second signal in response to the first signal, the second signal effective to control the power supply.

9. The levitation microreactor as recited in claim 1, wherein the first levitation zone further comprises a first droplet injector effective to inject the first reactant droplet into the first levitation zone, and wherein the second levitation zone further comprises a second droplet injector effective to inject the second reactant droplet into the second levitation zone.

10. The levitation microreactor as recited in claim 9, wherein the first droplet injector further includes one or more of a capillary tube, a striker, and/or a syringe pump.

11. The levitation microreactor as recited in claim 9, wherein the first droplet injector is effective to impart an electrical charge to the first reactant droplet.

12. The levitation microreactor as recited in claim 1, further comprising:
a third levitator in the third levitation zone, wherein the third levitator is effective to move the product;
a reaction detector in the third levitation zone, the reaction detector effective to measure the chemical reaction in the third levitation zone and produce a first signal; and
a processor in communication with the reaction detector, the processor effective to receive the first signal and to produce a second signal in response to the first signal, the second signal effective to control at least one of the first, second or third levitators to move the product.

13. The levitation microreactor as recited in claim 12, wherein the reaction detector comprises one or more of a laser detector, a light absorbance spectroscopy detector, a Raman spectroscopy detector, an IR spectroscopy detector, and/or a UV spectroscopy detector.

14. The levitation microreactor as recited in claim 9, further comprising:
a processor arranged in communication with the first and second droplet injectors,
wherein the processor is effective to control the first and second droplet injectors to inject the first and second droplets.

15. The levitation microreactor as recited in claim 1, further comprising a fourth levitation zone arranged in spatial communication with the third levitation zone, the fourth levitation zone including a third levitator, the third levitator effective move the product.

16. The levitation microreactor as recited in claim 1, wherein the third levitation zone includes a third levitator, wherein the third levitator is effective to move the product.

17. The levitation microreactor as recited in claim 1, further comprising a fourth levitation zone arranged in spatial communication with the third levitation zone, wherein the fourth levitation zone is effective to facilitate another reaction on the product.

18. The levitation microreactor as recited in claim 1, wherein the first, second and third levitation zones are sealed in a housing, and wherein the housing includes a port.

19. A method for a levitation microreactor to facilitate a chemical reaction between a first reactant droplet and a second reactant droplet to produce a product, the method comprising:
injecting the first reactant droplet into a first levitation zone of the levitation microreactor;
levitating the first reactant droplet in the first levitation zone with a first levitator;
injecting the second reactant droplet into a second levitation zone that is distinct from and in spatial communication with the first levitation zone;
levitating the second reactant droplet in the second levitation zone with a second levitator, the second reactant droplet being distinct from the first reactant droplet;
moving the first reactant droplet from the first levitation zone into a third zone;
moving the second reactant droplet from the second levitation zone into the third zone;
levitating the first and second reactant droplets in the third zone;
while the first and second reactant droplets are levitated in the third zone, facilitating the chemical reaction between the first reactant droplet and the second reactant droplet to produce the product; and
moving the product from the third zone.

20. A method for a levitation microreactor to facilitate a chemical reaction between a first reactant droplet and a second reactant droplet to produce a product, the method comprising:
injecting the first reactant droplet into a first levitation zone of the levitation microreactor;
levitating the first reactant droplet in the first levitation zone with a first levitator;
injecting the second reactant droplet into a second levitation zone that is in spatial communication with the first levitation zone;
levitating the second reactant droplet in the second levitation zone with a second levitator, the second reactant droplet being distinct from the first reactant droplet;
moving the first reactant droplet from the first levitation zone into a third zone;
moving the second reactant droplet from the second levitation zone into the third zone;
levitating the first and second reactant droplets in the third zone; and
while the first and second reactant droplets are levitated in the third zone, facilitating the chemical reaction between the first reactant droplet and the second reactant droplet to produce the product;
moving the product from the third zone;
wherein while carrying out the chemical reaction, the method further comprises:
injecting another first reactant droplet into the first levitation zone; and
injecting another second reactant droplet into the second levitation zone.

21. The method as recited in claim 19, further comprising collecting the product in a collector.

22. A method for a levitation microreactor to facilitate a chemical reaction between a first reactant droplet and a second reactant droplet to produce a product, the method comprising:
injecting the first reactant droplet into a first levitation zone of the levitation microreactor;
levitating the first reactant droplet in the first levitation zone with a first levitator;
injecting the second reactant droplet into a second levitation zone that is in spatial communication with the first levitation zone;
levitating the second reactant droplet in the second levitation zone with a second levitator, the second reactant droplet being distinct from the first reactant droplet;
moving the first reactant droplet from the first levitation zone into a third zone;
moving the second reactant droplet from the second levitation zone into the third zone;
levitating the first and second reactant droplets in the third zone;
while the first and second reactant droplets are levitated in the third zone, facilitating the chemical reaction between the first reactant droplet and the second reactant droplet to produce the product; and
moving the product from the third zone;
wherein facilitating the chemical reaction further comprises introducing a gaseous reactant into the third zone.

23. The method as recited in claim 19, wherein the first and second levitators are distinct from one another.

24. The method as recited in claim 19, further comprising:
detecting, by a droplet position detector in the first levitation zone, a position of the first droplet in the first levitation zone; and
generating, by the droplet position detector, a first signal that identifies the position of the first droplet in the first levitation zone.

25. A method for a levitation microreactor to facilitate a chemical reaction between a first reactant droplet and a second reactant droplet to produce a product, the method comprising:
injecting the first reactant droplet into a first levitation zone of the levitation microreactor;
levitating the first reactant droplet in the first levitation zone with a first levitator;
injecting the second reactant droplet into a second levitation zone that is in spatial communication with the first levitation zone;
levitating the second reactant droplet in the second levitation zone with a second levitator, the second reactant droplet being distinct from the first reactant droplet;
moving the first reactant droplet from the first levitation zone into a third zone;
moving the second reactant droplet from the second levitation zone into the third zone;
levitating the first and second reactant droplets in the third zone;
while the first and second reactant droplets are levitated in the third zone, facilitating the chemical reaction between the first reactant droplet and the second reactant droplet to produce the product;
moving the product from the third zone;
detecting, by a droplet position detector in the first levitation zone, a position of the first droplet in the first levitation zone;
generating, by the droplet position detector, a first signal that identifies the position of the first droplet in the first levitation zone;
receiving, by a processor arranged in communication with the droplet position detector, the first signal; and
generating, by the processor, a second signal effective to control the first levitator to move the first droplet in response to the first signal.

26. The method as recited in claim 25, wherein the first levitator is an electrostatic levitator comprising at least one electrode bar, and an electrode plate configured in spatial arrangement with the electrode bar, wherein the electrode bar and the electrode plate are effective to generate a levitation field in a levitation area when a potential difference is applied between the electrode bar and the electrode plate, and wherein the second signal is effective to control the potential difference.

27. The method as recited in claim 19, further comprising:
injecting the first reactant droplet into the first levitation zone using a first droplet injector; and
injecting the second reactant droplet into the second levitation zone using a second droplet injector.

28. The method as recited in claim 19, further comprising:
moving the product to a fourth zone, wherein the fourth zone is arranged in spatial communication with the third zone; and
carrying out another reaction on the product in the fourth zone.

29. The method as recited in claim 19, wherein moving the first reactant droplet includes moving by at least one of the first levitator, the second levitator, light tweezers, air pressure and/or ultrasound blast.

30. A computer storage medium having computer-executable instructions stored thereon which, when executed by a computing device, adapt the computing device to perform a method for a levitated microreactor to facilitate a chemical reaction between a first reactant droplet and a second reactant droplet to produce a product, the method comprising:
injecting the first reactant droplet into a first levitation zone of the levitation microreactor;
levitating the first reactant droplet in the first levitation zone with a first levitator;
injecting the second reactant droplet into a second levitation zone that is distinct from and in spatial communication with the first levitation zone;
levitating the second reactant droplet in the second levitation zone with a second levitator, the second reactant droplet being distinct from the first reactant droplet;
moving the first reactant droplet from the first levitation zone into a third zone;
moving the second reactant droplet from the second levitation zone into the third zone;
levitating the first and second reactant droplets in the third zone;
while the first and second reactant droplets are levitated in the third zone, facilitating the chemical reaction between the first reactant droplet and the second reactant droplet to produce the product; and
moving the product from the third zone.

31. The computer readable storage medium as recited in claim 30, wherein the method further comprises:
injecting the first reactant droplet into the first levitation zone using a first droplet injector; and
injecting the second reactant droplet into the second levitation zone using a second droplet injector.

32-39. (canceled)
